(19) United States
(12) Patent Application Publication
(10) Pub. No.: US 2006/0210248 A1
(43) Pub. Date: Sep. 21, 2006

(54) Information recording apparatus and information

(75) Inventor: Michio Yamashita, Inagi-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/376,313

(22) Filed: Mar. 16, 2006

(30) Foreign Application Priority Data
Mar. 18, 2005 (JP) 2005-079625

(51) Int. Cl. H04N 7/00

(52) U.S. Cl. 386/95

(57) ABSTRACT

According to one embodiment, an information recording method acquires a recording target video/audio content, divides the acquired recording target video/audio content into a plurality of data units, compares the obtained plurality of data units with a plurality of data units included in a video/audio content stored in a storage unit in advance, and based on the comparison result, deletes, of identical data units, a data unit belonging to the recording target video/audio content other than a data unit stored in the storage unit, and records, in the storage unit, the recording target video/audio content together with playback control information for complementing the deleted data unit upon accessing the remaining data unit.

### CROSS-REFERENCE TO RELATED APPLICATIONS

This application is based upon and claims the benefit of priority from Japanese Patent Application No. 2005-079625, filed Mar. 18, 2005, the entire contents of which are incorporated herein by reference.

### BACKGROUND

1. Field

One embodiment of the invention relates to an information recording apparatus and information recording method for receiving and recording a broadcast program (video/audio contents).

2. Description of the Related Art

In recent years, a digital recording apparatus has rapidly become popular. Since the amount of video data is much larger than that of audio data, a compression technique is indispensable to record video data. For example, Jpn. Pat. Appln. KOKAI Publication No. 2002-271744 discloses, as a video data compression method, a technique of compressing the video data by using difference information between frames.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a block diagram showing the schematic arrangement of an information recording apparatus according to an embodiment of the invention;

FIG. 2 is a view showing chapter information according to the embodiment;

FIG. 3 is a view for explaining the first compression recording scheme according to the embodiment;

FIG. 4 is a view for explaining a method of compressing one video/audio content by using difference information between frames in the video/audio content according to the embodiment; and

FIG. 5 is a view for explaining an example of the second compression recording scheme according to the embodiment.

### DETAILED DESCRIPTION

Various embodiments according to the invention will be described hereinafter with reference to the accompanying drawings. In general, according to one embodiment of the invention, an information recording method comprises acquiring a recording target video/audio content, dividing the acquired recording target video/audio content into a plurality of data units, comparing the obtained plurality of data units with a plurality of data units included in a video/audio content stored in a storage unit in advance, and based on a comparison result, deleting, of identical data units, a data unit belonging to the recording target video/audio content other than a data unit stored in the storage unit, and record, in the storage unit, the recording target video/audio content together with playback control information for complementing the deleted data unit upon accessing the remaining data unit.

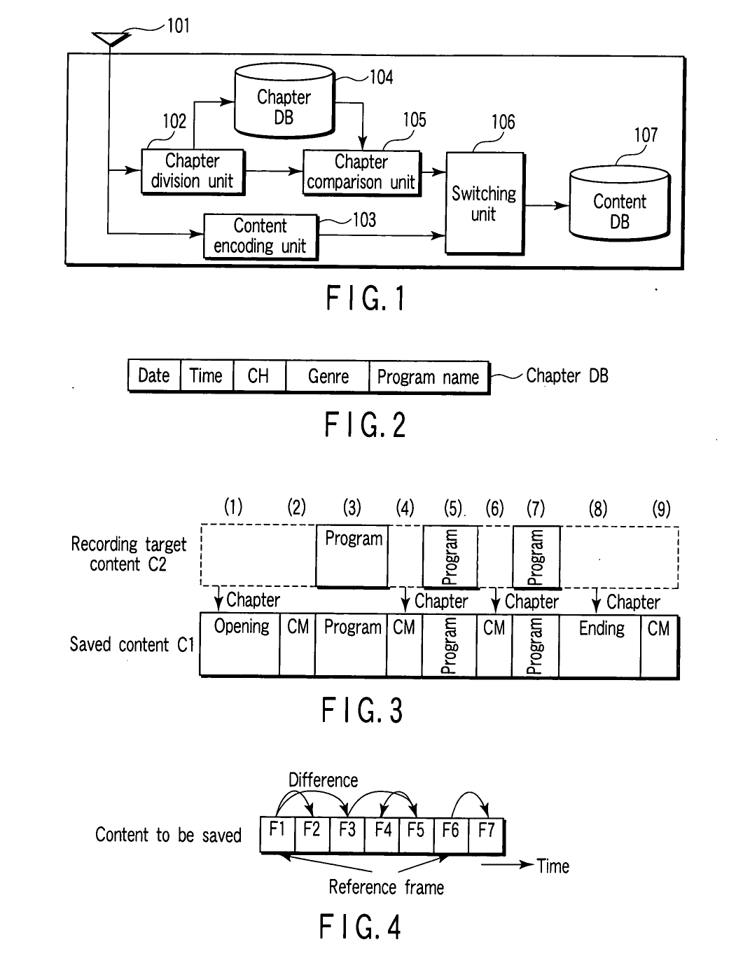

FIG. 1 is a block diagram showing the schematic arrangement of an information recording apparatus according to an embodiment of the invention.

As shown in FIG. 1, the information recording apparatus includes a reception antenna 101, chapter division unit 102, content encoding unit 103, chapter DB (database) 104, chapter comparison unit 105, switching unit 106, and content DB (database) 107. For example, the content DB 107 comprises as a hard disk drive (HDD).

The reception antenna 101 receives a broadcast signal. When the broadcast signal is to be received via a network, a network connection terminal is used in place of the reception antenna 101 to receive the broadcast signal via the network connection terminal.

On the basis of a predetermined condition, the chapter division unit 102 detects a division point of a video/audio content included in the broadcast signal received by the reception antenna 101, and defines a chapter by using the detected division point as a boundary. For example, the chapter division unit 102 detects a change (break) of video data, and defines the chapter by using the detected change as the boundary. The chapter division unit 102 also detects a change (break) of audio data, and defines the chapter by using the detected change as the boundary. With this operation, the opening of a program, a television commercial between the programs, or the like can be defined as one chapter.

Note that the boundary in the video/audio content may be detected by a method other than the above-described method. A user (TV viewer) need not be notified of the presence of a chapter defined by the information recording apparatus. Alternatively, the user (TV viewer) may define a chapter.

The chapter DB 104 registers chapter information (management information) pertaining to a chapter defined by the chapter division unit 102. The chapter information is information (e.g., EPG) pertaining to the video/audio content serving as a division source. For example, as shown in FIG. 2, the chapter information includes at least one of pieces of information such as the generation date (day of week), generation time, channel, genre (drama, animation, or the like), and program name of the video/audio content. The chapter information is received via the reception antenna 101. The chapter information may be received via the network.

The content encoding unit 103 encodes the video/audio content for each chapter defined by the chapter division unit 102. That is, the content encoding unit 103 generates a video/audio content including encoded chapter data units. The content DB 107 stores a plurality of video/audio contents each having encoded chapter data units.

The first compression recording scheme of a video/audio content according to this embodiment will be described next. In the first compression recording scheme, identical chapter data of a plurality of (e.g., two) different video/audio contents are detected. The chapter data belonging to one video/audio content is deleted, and the chapter data belonging to the other content remains. Link information using the remaining chapter data in place of the deleted chapter data is generated, and this link information and the video/audio content having undergone the deleting process are recorded together.

For example, the content DB 107 stores a plurality of video/audio contents each having a plurality of chapter data units. In this state, assume that a recording target video/audio content is acquired from the reception antenna 101. On the basis of a predetermined condition, the chapter division unit 102 detects the division point of the recording target video/audio content, and defines a chapter by using the detected division point as a boundary. The chapter DB 104 registers chapter information pertaining to the chapter defined by the chapter division unit 102. The content encoding unit 103 encodes the recording target video/audio content for each chapter defined by the chapter division unit 102.

The chapter comparison unit 105 compares the plurality of chapter data units stored in the content DB 107 with the plurality of chapter data units included in the recording target video/audio content. The chapter comparison unit 105 detects the presence of identical chapter data, and notifies the switching unit 106 and chapter DB 104 of the detection result of the identical chapter data.

On the basis of the detection result of the identical chapter data, the switching unit 106 does not select (acquire), from the plurality of chapter data units in the recording target video/audio content supplied from the content encoding unit 103, the chapter data unit (identical chapter data unit) determined to be identical to the chapter data unit stored in the content DB 107. This unselected chapter data is deleted.

On the other hand, on the basis of the detection result of the identical chapter, the switching unit 106 selects (acquires), from the plurality of chapter data units in the recording target video/audio content supplied from the content encoding unit 103, the chapter data unit (nonidentical chapter data unit) determined not to be identical to the chapter data unit stored in the content DB 107.

As a result, of the plurality of chapter data units included in the recording target video/audio content, the chapter data unit which is not identical to that in the content DB 107 is compressed to be newly stored in the content DB 107. Playback control information for complementing the deleted chapter data unit is additionally supplied to the recording target video/audio content to be stored in the content DB 107. More specifically, of the identical chapter data units, the chapter data unit stored in the content DB 107 remains, and the chapter data unit belonging to the recording target video/audio content is deleted. Hence, the playback control information for complementing the deleted chapter data unit is supplied upon accessing the remaining chapter data unit.

Note that playback control information is supplied to all the video/audio contents. For example, playback control information includes information such as storage destination addresses of the plurality of chapter data units (storage destination addresses of substitute chapter data units when the chapter units are deleted upon determination of identical chapter data units) included in the video/audio content, and the playback order of the chapter data units. For example, the playback control information is generated by the content encoding unit 103.

The example of the first compression recording scheme will now be described with reference to FIG. 3.

As shown in FIG. 3, assume that the content DB 107 has already stored a video/audio content C1 in advance. The video/audio content C1 includes a plurality of chapters defined by the chapter division unit 102 in recording. For example, the video/audio content C1 includes chapter data (1) corresponding to an opening, chapter data (2, 4, 6, and 9) corresponding to several television commercials, chapter data (3, 5, and 7) corresponding to program main parts, and chapter data (8) corresponding to an ending.

Assume that the program name of a recording target video/audio content C2 is the same as that of the already saved video/audio content Cl. For example, the video/audio contents C1 and C2 are the contents of a program broadcast every week, and the broadcast timings of these contents have a time difference of a week. The recording target video/audio content C2 is acquired by the reception antenna 101. On the basis of a predetermined condition, the chapter division unit 102 detects the division points of the recording target video/audio content C2 to define the chapter by using the detected division points as the boundaries.

Accordingly, the video/audio content C2 is divided into chapter data (1) corresponding to an opening, chapter data (2, 4, 6, and 9) corresponding to several television commercials, chapter data (3, 5, and 7) corresponding to program main parts, and chapter data (8) corresponding to an ending. The chapter DB 104 registers the chapter information pertaining to the chapters defined by the chapter division unit 102. The content encoding unit 103 encodes the recording target video/audio content C2 for each chapter data unit defined by the chapter division unit 102.

The chapter comparison unit 105 compares the plurality of chapter data units (1 to 9) included in the already saved video/audio content C1 with those included in the recording target video/audio content C2. For example, the chapter data (1) corresponding to the opening, the chapter data (2, 4, 6, and 9) corresponding to the several television commercials, and the chapter data (8) corresponding to the ending are determined to be identical. Accordingly, of identical chapter data units (1, 2, 4, 6, 8, and 9), chapter data units (1, 2, 4, 6, 8, and 9) stored in the content DB 107 remain, and chapter data units (1, 2, 4, 6, 8, and 9) belonging to the recording target video/audio content are deleted. The content DB 107 newly stores the recording target video/audio content C2 (after deleting the identical chapter data units) together with the playback control information for complementing the deleted chapter data units upon accessing the remaining chapter data units. At this time, each chapter data included in the video/audio content C2 is compressed and stored.

The chapter comparison unit 105 can also select the chapter data units which are probably identical, at low cost in a short period of time by using the chapter information. For example, when the video/audio contents are in the same drama (having the same program name), these video/audio contents are broadcast in the same time on the same day every week, and have the same opening, ending, and inserted television commercials.

In the above description, the comparison and deleting processes for the identical chapter data are performed in real time. However, the present invention is not limited to this. For example, the recording target video/audio content may be directly recorded without comparison and deleting processes, and these processes may be performed after recording.

In a case wherein two contents whose timings have a predetermined time difference (e.g., one week) are to be compared, sometimes, an actual broadcasting time does not completely match a time stored in the information recording apparatus. Hence, the start position of the chapter is detected within a certain time range, and the chapters are synchronized and compared for each frame.

The chapter data corresponding to the opening, television commercials, and ending of the same program (having the same program name) are probably identical data. However, even in the same program, the chapter data corresponding to the main parts are not probably identical data. Hence, when the chapter data is determined to correspond to the main part in accordance with the chapter information, the chapter comparison unit 105 can omit the comparison process for the chapter data determined as the chapter data corresponding to the main part.

When a broadcasting station side distributes saving identification information as one of pieces of chapter information, the comparison process can be further simplified. The saving identification information is information indicating whether the chapter is to be saved (the chapter has high originality), or already broadcast (the chapter has low originality). That is, the information recording apparatus can determine the originality of each chapter data included in the recording target video/audio content, on the basis of the saving identification information. The chapter data having high originality is directly recorded and saved without any comparison process. The information recording apparatus performs the comparison process for the chapter data having low originality to determine whether to directly record and save the chapter data, or discard it because of the presence of the identical chapter data. Thus, in accordance with the saving identification information, the frequency of the comparison processes can be lowered. The broadcasting station side can also expect that a lot of program data can be saved or viewed by the viewer.

In a conventional compression scheme, e.g., a compression scheme implemented by changing a bitrate, a program video quality degrades. However, in the first compression recording scheme according to this embodiment, one of two identical chapter data is deleted, and the other chapter data remains. The remaining chapter data is used in place of the deleted data, and the program video quality does not degrade. Additionally, no load for the viewer is imposed.

The second compression recording scheme of the video/audio content according to this embodiment will be described next. In the second compression recording scheme, the difference information between the frames (data units) of the plurality of (e.g., two) different video/audio contents is generated. In accordance with this difference information, one content is compressed and recorded.

For example, as shown in FIG. 4, a method of compressing one video/audio content by using the difference information between its frames has been used. However, in the second compression recording scheme according to this embodiment, the already saved video/audio content C1 is compared with the recording target video/audio content C2, and the recording target video/audio content C2 is compressed by using the obtained difference information.

In the above-described first compression recording scheme, the identical chapter data can be effectively compressed. However, when the chapter data have a small difference, the compression effect decreases. For example, the chapter data corresponding to the openings of the respective two video contents are assumed to have a small difference. More specifically, the parts (e.g., names of the cast) of the opening videos are assumed to be different from each other.

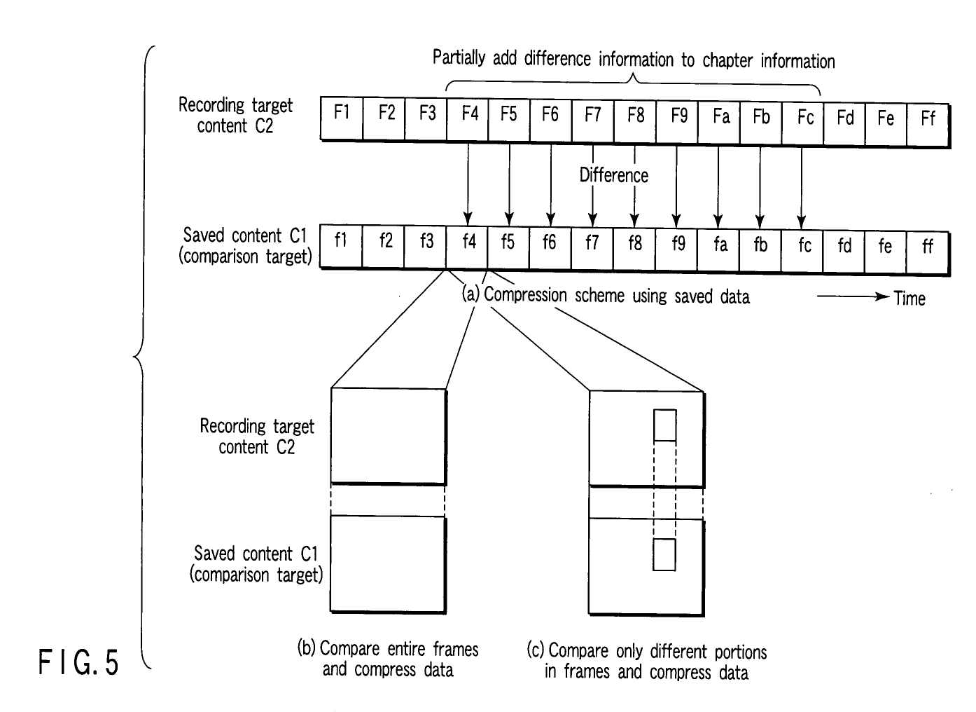

As shown in (a) of FIG. 5, in the second compression recording scheme, the difference information between the frames of the video/audio content C1 in the content DB 107 and the recording target video/audio content C2 is detected to compress the recording target video/audio content C2 on the basis of the detected difference information. In the second compression recording scheme, the information processing apparatus can effectively compress the recording target video/audio content C2 including the chapter data slightly different from that of the video/audio content C1 saved in the content DB 107.

As shown in (b) of FIG. 5, the entire frame in which a difference is detected in the recording target video/audio content C2 may be compared with that in the saved video/audio content C1 to perform the compression process. Also, as shown in (c) of FIG. 5, only a part of the frame in which a difference is detected in the recording target video/audio content C2 may be compared with that in the saved video/audio content C1 to perform the compression process.

More specifically, with reference to the frame data of the saved video/audio content C1, the chapter comparison unit 105 compares the frame data of the video/audio content C1 with that of the recording target video/audio content C2 to obtain the difference information. The content encoding unit 103 compresses the recording target video/audio content C2 on the basis of the reference data information and the difference information. As a result, the content DB 107 stores the recording target video/audio content C2 which is compressed based on the reference data information and the difference information.

In addition to the technique of compressing the recording target video/audio content C2 upon comparing it with the saved video/audio content C1, a scheme of compressing (compressing an entire or part of the screen) the video/audio content by using the difference information between the frames of the recording target video/audio content C2 itself as shown in FIG. 4 can also be used together.

The third compression recording scheme of the video/audio content according to this embodiment will be described next. In the third compression recording scheme, the chapter data is further divided to increase the number of identical chapter data in each of the plurality of (e.g., two) different video/audio contents. Of two identical chapter data, the chapter data belonging to one video/audio content is deleted, and the chapter data belonging to the other content remains. In this system, the link information using the remaining chapter data in place of the deleted chapter data is generated, and this link information and the video/audio content having undergone the deleting process are recorded together.

That is, by adjusting the determination condition of the division point in the chapter division unit 102, more division points are detected in one video/audio content to define more chapters for each video/audio content. For example, the boundary is preferentially detected by using a change (break) of video and audio data, and the boundary is further detected at a predetermined time interval. With this operation, one chapter defined by the change (break) of the video and audio data as a boundary can be divided into the plurality of chapters at a predetermined time interval. For example, one chapter corresponding to an opening video can be divided into a plurality of chapters at a predetermined time interval.

For example, assume that predetermined chapter data (chapter data corresponding to the opening video) of the video/audio content C1 saved in the content DB 107 is slightly different from that of the recording target video/audio content C2 (e.g., the names of the cast are changed). That is, the predetermined chapter data of the video/audio content C1 saved in the content DB 107 is not identical to that of the recording target video/audio content C2. In this case, the predetermined chapter data of the video/audio content C1 saved in the content DB 107 is further divided into the plurality of chapter data, and that of the recording target video/audio content C2 is also divided into the plurality of chapter data. As a result, several identical chapters can be detected, and one identical chapter can be deleted to compress the data.

For example, the third compression recording scheme may be applied when the content DB 107 becomes almost full.

In the conventional compression scheme, e.g., the compression scheme implemented by changing the bitrate, the quality of the program video degrades. However, in the third compression recording scheme according to this embodiment, one of two identical chapter data is deleted, and the remaining chapter data is used in place of the deleted chapter data. Hence, the quality of the program video does not degrade. Additionally, no load for the viewer is imposed.

Note that the above-described first, second, and third compression recording schemes may be executed in real time, or in the light-load state of the system.

As described above, according to this embodiment, effective compression recording can be done, and more video/audio contents can be saved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording apparatus comprising:
a storage unit configured to store a video/audio content including a plurality of data units;
an acquisition unit configured to acquire a recording target video/audio content;
a division unit configured to divide, into the plurality of data units, the recording target video/audio content which is acquired by the acquisition unit;
a comparison unit configured to compare the plurality of data units obtained by the division unit with the plurality of data units stored in the storage unit; and
a recording unit configured to delete, of identical data units based on a comparison result obtained by the comparison unit, a data unit belonging to the recording target video/audio content other than a data unit stored in the storage unit, and record, in the storage unit, the recording target video/audio content together with playback control information for complementing the deleted data unit upon accessing the remaining data unit.

2. An apparatus according to claim 1, which further comprises a management unit configured to manage management information corresponding to each data unit, and in which the comparison unit selects comparison target data units based on the management information which is managed by the management unit and corresponds to each data unit, and compares the selected comparison target data units with each other.

3. An apparatus according to claim 2, wherein the management information includes at least one of pieces of information indicating a generation date, a generation time, a channel, a genre, and a program name of the video/audio content.

4. An apparatus according to claim 1, wherein the division unit detects at least one of a change of audio data and a change of video data in the recording target video/audio content, and divides the recording target video/audio content into a plurality of data units.

5. An information recording apparatus comprising:
a storage unit configured to store a video/audio content including a plurality of data units;
an acquisition unit configured to acquire a recording target video/audio content;
a division unit configured to divide, into the plurality of data units, the recording target video/audio content which is acquired by the acquisition unit;
a comparison unit configured to compare the plurality of data units as reference data stored in the storage unit with the plurality of data units obtained by the division unit; and
a recording unit configured to acquire difference information based on a comparison result obtained by the comparison unit, compress the recording target video/audio content based on information pertaining to the reference data and the difference information, and record the compressed recording target video/audio content in the storage unit.

6. An apparatus according to claim 5, which further comprises a management unit configured to manage management information corresponding to each data unit, and in which the comparison unit selects comparison target data units based on the management information which is managed by the management unit and corresponds to each data unit, and compares the selected comparison target data units with each other.

7. An apparatus according to claim 6, wherein the management information includes at least one of pieces of information indicating a generation date, a generation time, a channel, a genre, and a program name of the video/audio content.

8. An apparatus according to claim 5, wherein the division unit detects at least one of a change of audio data and a change of video data in the recording target video/audio content, and divides the recording target video/audio content into a plurality of data units.

9. An information recording method comprising:
acquiring a recording target video/audio content;
dividing the acquired recording target video/audio content into a plurality of data units;
comparing the obtained plurality of data units with a plurality of data units included in a video/audio content stored in a storage unit in advance; and
based on a comparison result, deleting, of identical data units, a data unit belonging to the recording target video/audio content other than a data unit stored in the storage unit, and record, in the storage unit, the recording target video/audio content together with playback control information for complementing the deleted data unit upon accessing the remaining data unit.

10. A method according to claim 9, which further comprises managing management information corresponding to each data unit, and in which comparison target data units are selected based on the management information which is managed by the management unit and corresponds to each data unit, and compares the selected comparison target data units with each other.

11. A method according to claim 10, wherein the management information includes at least one of pieces of information indicating a generation date, a generation time, a channel, a genre, and a program name of the video/audio content.

12. A method according to claim 9, wherein at least one of a change of audio data and a change of video data in the recording target video/audio content is detected, and the recording target video/audio content is divided into a plurality of data units.

13. An information recording method comprising:
acquiring a recording target video/audio content;
dividing the acquired recording target video/audio content into the plurality of data units;
comparing the plurality of data units as reference data stored in the storage unit in advance with the plurality of obtained data units; and
acquiring difference information based on a comparison result, compressing the recording target video/audio content based on information pertaining to the reference data and the difference information, and recording the compressed recording target video/audio content in the storage unit.

14. A method according to claim 13, which further comprises managing management information corresponding to each data unit, and in which comparison target data units are selected based on the management information which is managed by the management unit and corresponds to each data unit, and the selected comparison target data units are compared with each other.

15. A method according to claim 14, wherein the management information includes at least one of pieces of information indicating a generation date, a generation time, a channel, a genre, and a program name of the video/audio content.

16. A method according to claim 13, wherein at least one of a change of audio data and a change of video data in the recording target video/audio content is detected, and the recording target video/audio content is divided into a plurality of data units.
